(19) United States
(12) Patent Application Publication
(10) Pub. No.: US 2026/0153176 A1
(43) Pub. Date: Jun. 4, 2026

(54) VALVE CONNECTOR

(71) Applicant: Co-Luck Enterprise Co., Ltd., Taichung City (TW)

(72) Inventor: Scott Wu, Taichung City (TW)

(21) Appl. No.: 18/966,846

(22) Filed: Dec. 3, 2024

(51) Int. Cl. F16L 37/35; F16K 24/00

(52) U.S. Cl. CPC F16L 37/35; F16K 24/00

(57) ABSTRACT

A valve connector for various air valves comprises a housing with a sliding slot along a virtual reference axis and a clamping device disposed therein. The clamping device includes an American pushing seat, a French pushing seat, a first clamping jaw with a first clamping portion, at least one second clamping jaw with a second clamping portion, and a pushing member in the American receiving hole. The clamping device alternates between an American position, where the first clamping portion is close to the axis, and a French position, where the second clamping portion is close to the axis. This design enables ease of operation and effective clamping performance.

### BACKGROUND OF THE INVENTION

The present invention primarily discloses a valve connector, and more particularly to a valve connector suitable for various types of air valves.

Taiwan Patent No. M641881 discloses a press-fastening anti-retraction type air nozzle joint structure, including a main body and two press-fastening devices; the main body has two external joint surfaces respectively combined with the press-fastening devices, and each press-fastening device has an integrally formed buckle component and a protruding button embedded inside; thereby, when the button is pressed by external force, the buckle teeth provided on the buckle component can be linked to withdraw from the channel of the main body, so that the tire air nozzle can be and inserted into the channel of the main body; and, when the button is not pressed by external force, the buckle teeth of the buckle member are restored to the channel of the main body, so that the two buckle teeth of the two buckle devices are respectively buckled on the outer sides of the tire valve.

However, the aforementioned air nozzle joint requires pressing the press-fastening devices both when inserting and withdrawing the air nozzle. Moreover, the operation must be performed by simultaneously pressing the two press-fastening devices with both fingers, which is not only cumbersome but also problematic. When the thrust of high pressure air drives the air nozzle to retract, the backward force of the air nozzle generates a radial component of force at the contact surface between the press-fastening devices and the air nozzle. This may cause the press-fastening devices to open and detach from the air nozzle due to the squeezing force exerted by the air nozzle.

### SUMMARY OF THE INVENTION

The main objective of the present invention is to provide a valve connector, which comprises a housing and a clamping device. The housing has a sliding slot arranged along a virtual reference axis. The housing is provided with a first end and a second end opposite to the first end along the reference axis. The sliding slot communicates the first end and the second end. The clamping device is disposed in the sliding slot. The clamping device includes an American pushing seat, a French pushing seat, a first clamping jaw, at least one second clamping jaw, and a pushing member. The American pushing seat is adjacent to the first end and is provided with an American receiving hole along the reference axis. The American pushing seat is provided with a first containing slot, and the first clamping jaw is disposed in the first containing slot. The French pushing seat is adjacent to the second end and is provided with a French receiving hole along the reference axis. The French pushing seat is provided with at least one second containing slot, and the at least one second clamping jaw is disposed in the at least one second containing slot. The pushing member is disposed in the American receiving hole. The first clamping jaw includes a first pivoting base and a first clamping arm. The first pivoting base is provided with a first pivoting portion. The first clamping arm is pivotally connected to the first pivoting base and is provided with a first clamping portion. The at least one second clamping jaw includes a second pivoting base and a second clamping arm. The second pivoting base is provided with a second pivoting portion. The second clamping arm is pivotally connected to the second pivoting base and is provided with a second clamping portion. The clamping device is slidable between an American position and a French position. When the clamping device is in the American position, the first clamping portion and the first pivoting portion are close to the reference axis, and the second clamping portion and the second pivoting portion are away from the reference axis. When the clamping device is in the French position, the first clamping portion and the first pivoting portion are away from the reference axis, and the second clamping portion and the second pivoting portion are close to the reference axis.

In an embodiment, an inner periphery of the sliding slot is provided with a first pushing surface adjacent to the first end and a second pushing surface adjacent to the second end. The first pivoting base is provided with a third pivoting portion pivotally connected to the American pushing seat. The second pivoting base is provided with a fourth pivoting portion pivotally connected to the French pushing seat. When the clamping device is in the American position, the first pivoting portion contacts the first pushing surface, causing the first clamping portion to move closer to the reference axis, and the second pivoting portion disengages from the second pushing surface, causing the second clamping portion to move away from the reference axis. When the clamping device is in the French position, the first pivoting portion disengages from the first pushing surface, causing the first clamping portion to move away from the reference axis, and the second pivoting portion contacts the second pushing surface, causing the second clamping portion to move closer to the reference axis.

In an embodiment, a distance from the first pivoting portion to the first end along the reference axis forms a first depth. A distance from the first clamping portion to the first end along the reference axis forms a second depth. The first depth is less than the second depth. A distance from the second pivoting portion to the second end along the reference axis forms a third depth. A distance from the second clamping portion to the second end along the reference axis forms a fourth depth. The third depth is less than the fourth depth. The clamping device slides between the American position and the French position to allow the first clamping jaw to rotate relative to the American pushing seat and the at least one second clamping jaw to rotate relative to the French pushing seat.

In an embodiment, a distance from the third pivoting portion to the first end along the reference axis forms a fifth depth. The fifth depth is greater than the second depth. A distance from the fourth pivoting portion to the second end along the reference axis forms a sixth depth. The sixth depth is greater than the fourth depth.

In an embodiment, the clamping device includes a first elastic member and at least one second elastic member. The first elastic member is a torsion spring disposed on the first pivoting portion. Two opposite ends of the first elastic member respectively press against the first pivoting base and the first clamping arm. The at least one second elastic member is a torsion spring disposed on the second pivoting portion. Two opposite ends of the at least one second elastic member respectively press against the second pivoting base and the second clamping arm.

In an embodiment, the American pushing seat is provided with a first pin inserted into the American pushing seat. The first pin is positioned within the first containing slots. The third pivoting portion is sleeved on the first pin and pivotally connected to the American pushing seat, with the first pin serving as the center of rotation. The French pushing seat is provided with at least one second pin inserted into the French pushing seat. The at least one second pin is positioned within the at least one second containing slot. The fourth pivoting portion is sleeved on the at least one second pin and pivotally connected to the French pushing seat, with the at least one second pin serving as the center of rotation.

In an embodiment, the French pushing seat is threadedly connected to the American pushing seat. When the clamping device is in the American position, the American pushing seat and the French pushing seat move synchronously toward the second end, and the French pushing seat protrudes from the second end of the housing. When the clamping device is in the French position, the American pushing seat and the French pushing seat move synchronously toward the first end, and the American pushing seat protrudes from the first end of the housing.

In an embodiment, the pushing member is inserted into the American receiving hole from an end of the American pushing seat adjacent to the second end. The clamping device includes a spring sleeved on the pushing member. One end of the spring abuts against the pushing member, and the other end of the spring abuts against the French pushing seat. The spring is configured to push against the pushing member to move away from the French pushing seat.

In an embodiment, an inner periphery of the American receiving hole is provided with an American sealing ring disposed on a side of the first clamping portion opposite to the first end. An periphery of the French receiving hole is provided with a French sealing ring disposed between the second clamping portion and the second end.

In an embodiment, the inner periphery of the sliding slot is provided with a limiting flange. The American pushing seat is disposed between the limiting flange and the first end. The French pushing seat is disposed between the limiting flange and the second end. When the clamping device is in the American position, the American pushing seat contacts one end of the limiting flange adjacent to the first end. When the clamping device is in the French position, the French pushing seat contacts one end of the limiting flange adjacent to the second end.

The present invention will become clearer in light of the following detailed description of illustrative embodiments of this invention described in connection with the drawings.

### BRIEF DESCRIPTION OF DRAWINGS

FIG. 1 is a perspective view of a valve connector of an embodiment according to the present invention.

FIG. 2 is an exploded perspective view of the valve connector of FIG. 1.

FIG. 3 is another exploded perspective view of the valve connector of FIG. 1.

FIG. 4 is a cross-sectional view of the valve connector of FIG. 1 and shows an American valve inserted into an American receiving hole.

FIG. 5 is a continued view of FIG. 4 and shows the American valve disengaged from the American receiving hole.

FIG. 6 is a cross-sectional view of the valve connector of FIG. 1 and shows a French valve inserted into a French receiving hole.

FIG. 7 is a continued view of FIG. 6 and shows the French valve disengaged from the French receiving hole.

### DETAILED DESCRIPTION OF THE INVENTION

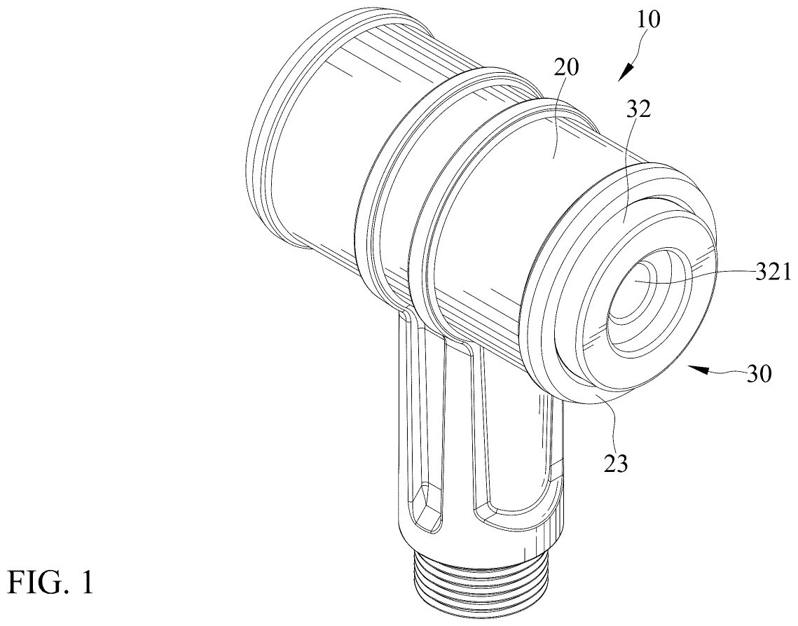

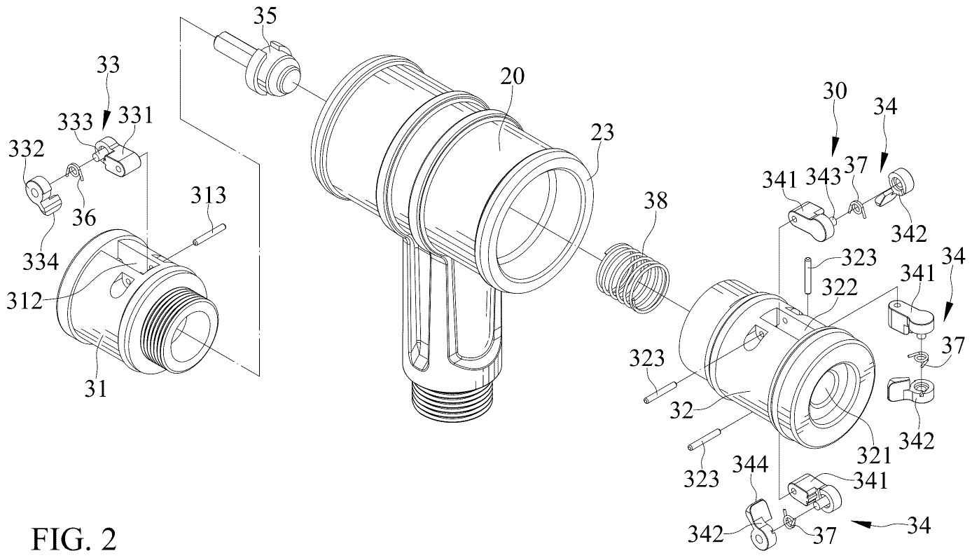

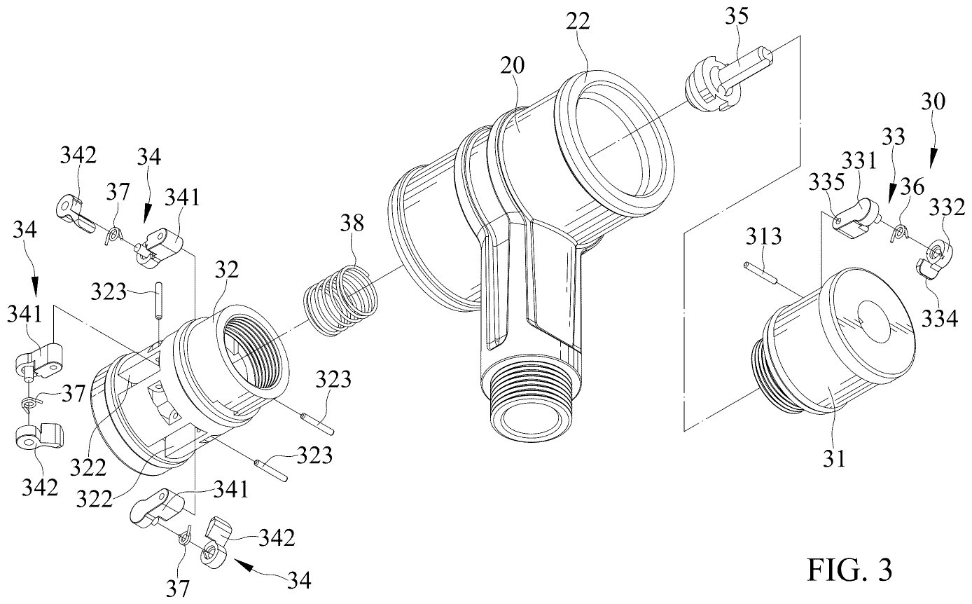

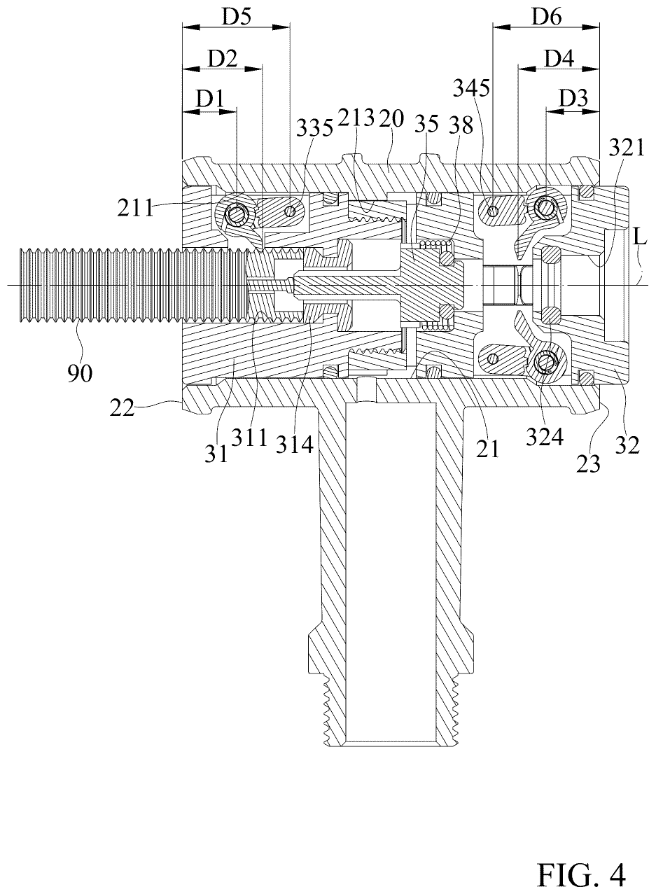

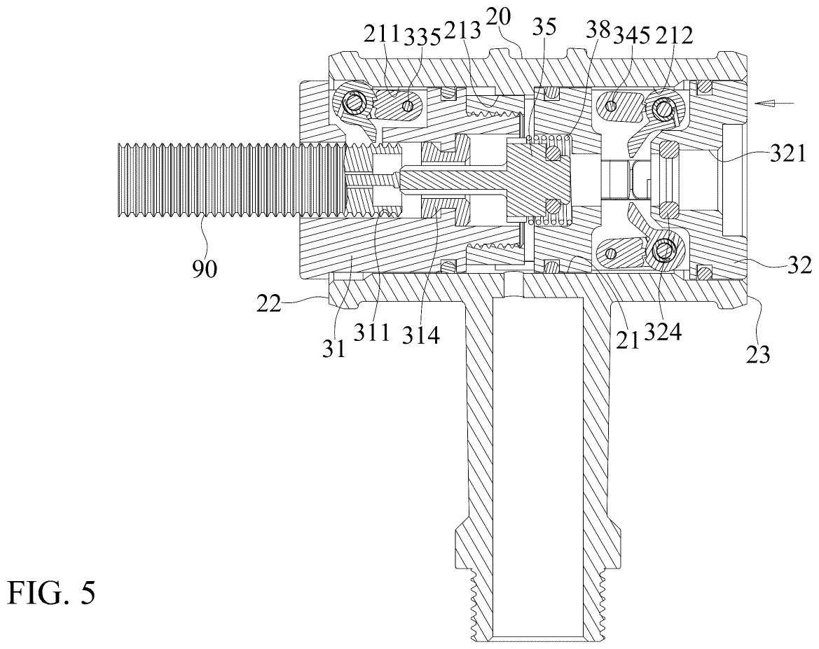

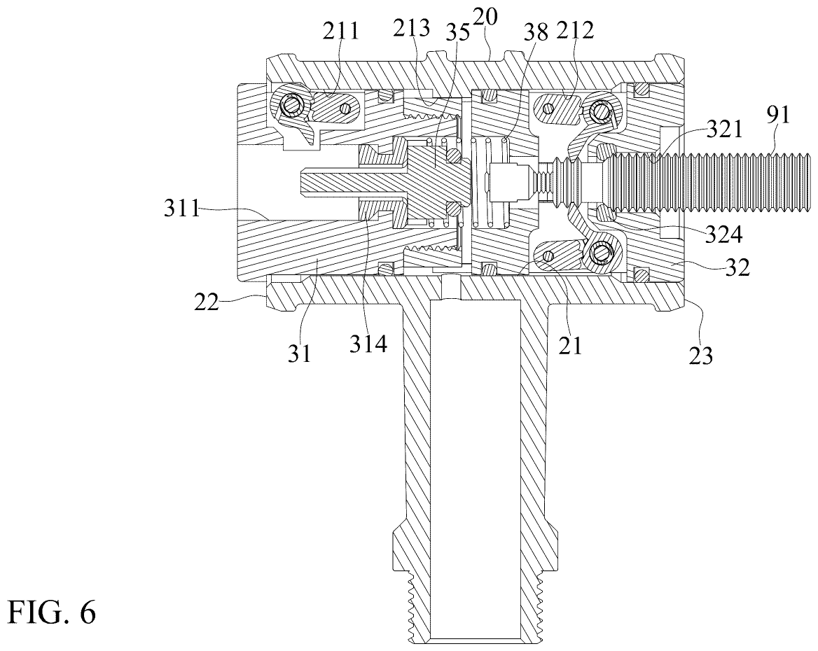

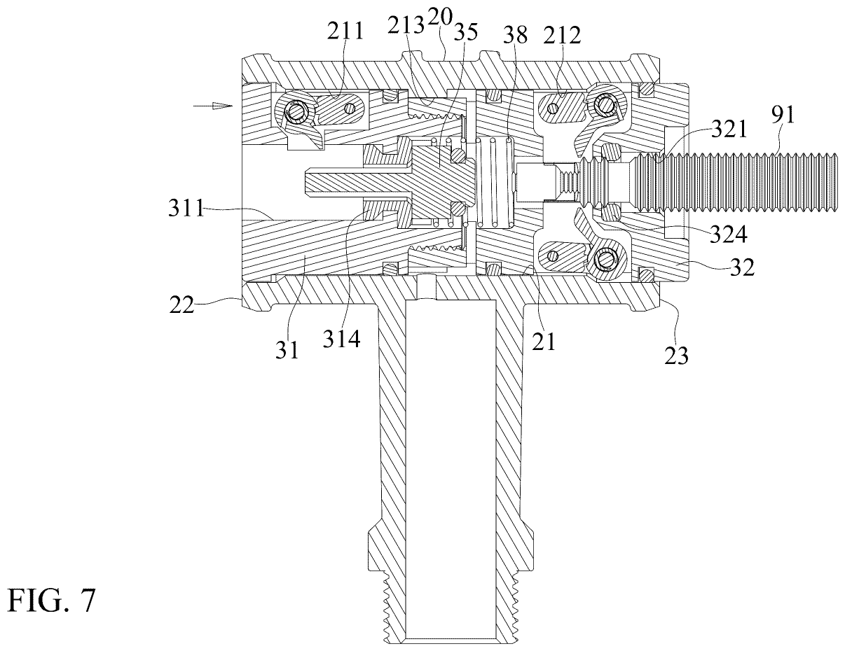

FIGS. 1-7 show a valve connector 10 of an embodiment according to the present invention. The valve connector 10 comprises a housing 20 and a clamping device 30.

The housing 20 has a sliding slot 21 arranged along a virtual reference axis L, and the housing 20 is provided with a first end 22 and a second end 23 opposite to the first end 22 along the reference axis L. The sliding slot 21 communicates the first end 22 and the second end 23.

The clamping device 30 is disposed in the sliding slot 21, and the clamping device 30 includes an American pushing seat 31, a French pushing seat 32, a first clamping jaw 33, at least one second clamping jaw 34, and a pushing member 35. The American pushing seat 31 is adjacent to the first end 22 and is provided with an American receiving hole 311 along the reference axis L. The American pushing seat 31 is provided with a first containing slot 312, and the first clamping jaw 33 is disposed in the first containing slot 312. The French pushing seat 32 is adjacent to the second end 23 and is provided with a French receiving hole 321 along the reference axis L. The French pushing seat 32 is provided with at least one second containing slot 322, and the at least one second clamping jaw 34 is disposed in the at least one second containing slot 322. The pushing member 35 is disposed in the American receiving hole 311. The first clamping jaw 33 includes a first pivoting base 331 and a first clamping arm 332. The first pivoting base 331 is provided with a first pivoting portion 333. The first clamping arm 332 is pivotally connected to the first pivoting base 331 and is provided with a first clamping portion 334. The at least one second clamping jaw 34 includes a second pivoting base 341 and a second clamping arm 342. The second pivoting base 341 is provided with a second pivoting portion 343. The second clamping arm 342 is pivotally connected to the second pivoting base 341 and is provided with a second clamping portion 344. The clamping device 30 is slidable between an American position and a French position. When the clamping device 30 is in the American position, the first clamping portion 334 and the first pivoting portion 333 are close to the reference axis L, and the second clamping portion 344 and the second pivoting portion 343 are away from the reference axis L. When the clamping device 30 is in the French position, the first clamping portion 334 and the first pivoting portion 333 are away from the reference axis L, and the second clamping portion 344 and the second pivoting portion 343 are close to the reference axis L.

An inner periphery of the sliding slot 21 is provided with a first pushing surface 211 adjacent to the first end 22 and a second pushing surface 212 adjacent to the second end 23. The first pivoting base 331 is provided with a third pivoting portion 335 pivotally connected to the American pushing seat 31. The second pivoting base 341 is provided with a fourth pivoting portion 345 pivotally connected to the French pushing seat 32. When the clamping device 30 is in the American position, the first pivoting portion 333 contacts the first pushing surface 211, causing the first clamping portion 334 to move closer to the reference axis L, and the second pivoting portion 343 disengages from the second pushing surface 212, causing the second clamping portion 344 to move away from the reference axis L. When the clamping device 30 is in the French position, the first pivoting portion 333 disengages from the first pushing surface 211, causing the first clamping portion 334 to move away from the reference axis L, and the second pivoting portion 343 contacts the second pushing surface 212, causing the second clamping portion 344 to move closer to the reference axis L.

A distance from the first pivoting portion 333 to the first end 22 along the reference axis L forms a first depth D1. A distance from the first clamping portion 334 to the first end 22 along the reference axis L forms a second depth D2. The first depth D1 is less than the second depth D2. A distance from the second pivoting portion 343 to the second end 23 along the reference axis L forms a third depth D3. A distance from the second clamping portion 344 to the second end 23 along the reference axis L forms a fourth depth D4. The third depth D3 is less than the fourth depth D4. The clamping device 30 slides between the American position and the French position to allow the first clamping jaw 33 to rotate relative to the American pushing seat 31 and the at least one second clamping jaw 34 to rotate relative to the French pushing seat 32.

A distance from the third pivoting portion 335 to the first end 22 along the reference axis L forms a fifth depth D5. The fifth depth D5 is greater than the second depth D2. A distance from the fourth pivoting portion 345 to the second end 23 along the reference axis L forms a sixth depth D6. The sixth depth D6 is greater than the fourth depth D4.

The clamping device 30 includes a first elastic member 36 and at least one second elastic member 37. The first elastic member 36 is a torsion spring disposed on the first pivoting portion 333. Two opposite ends of the first elastic member 36 respectively press against the first pivoting base 331 and the first clamping arm 332. The at least one second elastic member 37 is a torsion spring disposed on the second pivoting portion 343. Two opposite ends of the at least one second elastic member 37 respectively press against the second pivoting base 341 and the second clamping arm 342.

The American pushing seat 31 is provided with a first pin 313 inserted into the American pushing seat 31. The first pin 313 is positioned within the first containing slots 312. The third pivoting portion 335 is sleeved on the first pin 313 and pivotally connected to the American pushing seat 31, with the first pin 313 serving as the center of rotation. The French pushing seat 32 is provided with at least one second pin 323 inserted into the French pushing seat 32. The at least one second pin 323 is positioned within the at least one second containing slot 322. The fourth pivoting portion 345 is sleeved on the at least one second pin 323 and pivotally connected to the French pushing seat 32, with the at least one second pin 323 serving as the center of rotation.

The first pushing surface 211 and the second pushing surface 212 are concentrically arranged around the reference axis L along the inner periphery of the sliding slot 21. The clamping device 30 includes three second clamping jaws 34, and the French pushing seat 32 is provided with three second containing slots 322. The three second containing slots 322 are respectively in communication with the French receiving hole 321. The three second clamping jaws 34 are respectively disposed within the three second containing slots 322. The clamping device 30 further includes three second elastic members 37, each of which is disposed on the respective second pivoting portion 343 of the three second clamping jaws 34. The French pushing seat 32 is also provided with three second pins 323, which are inserted to the French pushing seat 32. The three second pins 323 are respectively positioned within the three second containing slots 322. The second pivoting portions 343 of the three second clamping jaws 34 are respectively sleeved on the three second pins 323 and pivotally connected to the French pushing seat 32, with each of the second pins 323 serving as the center of rotation.

The French pushing seat 32 is threadedly connected to the American pushing seat 31. When the clamping device 30 is in the American position, the American pushing seat 31 and the French pushing seat 32 move synchronously toward the second end 23, and the French pushing seat 32 protrudes from the second end 23 of the housing 20. When the clamping device 30 is in the French position, the American pushing seat 31 and the French pushing seat 32 move synchronously toward the first end 22, and the American pushing seat 31 protrudes from the first end 22 of the housing 20.

The pushing member 35 is inserted into the American receiving hole 311 from an end of the American pushing seat 31 adjacent to the second end 23. The clamping device 30 includes a spring 38 sleeved on the pushing member 35. One end of the spring 38 abuts against the pushing member 35, and the other end of the spring 38 abuts against the French pushing seat 32. The spring 38 is configured to push against the pushing member 35 to move away from the French pushing seat 32.

An inner periphery of the American receiving hole 311 is provided with an American sealing ring 314 disposed on a side of the first clamping portion 334 opposite to the first end 22. An periphery of the French receiving hole 321 is provided with a French sealing ring 324 disposed between the second clamping portion 344 and the second end 23.

The inner periphery of the sliding slot 21 is provided with a limiting flange 213. The American pushing seat 31 is disposed between the limiting flange 213 and the first end 22. The French pushing seat 32 is disposed between the limiting flange 213 and the second end 23. When the clamping device 30 is in the American position, the American pushing seat 31 contacts one end of the limiting flange 213 adjacent to the first end 22. When the clamping device 30 is in the French position, the French pushing seat 32 contacts one end of the limiting flange 213 adjacent to the second end 23.

The valve connector 10, through the above structure, ensures ease of operation and effective clamping performance. When using the valve connector 10, an American valve 90 can be directly inserted into the American receiving hole 311. When the clamping device 30 is in the American position, the American valve 90 is clamped by the first clamping portion 334, preventing the American valve 90 from disengaging. Simultaneously, the pushing member 35 presses against the valve core of the American valve 90, causing the American valve 90 to open. If the American valve 90 is pulled out in reverse, the first clamping portion 334 tightens further. To remove the American valve 90, the housing 20 can be held, and the French pushing seat 32 pressed, moving the clamping device 30 to the French position. This action releases the first pivoting portion 333 from the restriction of the first pushing surface 211. While pulling out the American valve 90, which pushes against the first clamping portion 334, causing the first clamping jaw 33 to retract, allowing the American valve 90 to be disengaged. Similarly, the French valve 91 can be inserted into the French receiving hole 321 and clamped by the second clamping portion 344. Pressing the American pushing seat 31 moves the clamping device 30 to the American position. While pulling out the French valve 91, the French valve 91 pushes against the second clamping portion 344, causing the second clamping jaw 34 to retract, thereby allowing the French valve 91 to be removed.

Although specific embodiments have been illustrated and described, numerous modifications and variations are still possible without departing from the scope of the invention. The scope of the invention is limited by the accompanying claims.

1. A valve connector, comprising:
a housing having a sliding slot arranged along a virtual reference axis, wherein the housing is provided with a first end and a second end opposite to the first end along the reference axis, and wherein the sliding slot communicates the first end and the second end; and
a clamping device disposed in the sliding slot, wherein the clamping device includes an American pushing seat, a French pushing seat, a first clamping jaw, at least one second clamping jaw, and a pushing member, wherein the American pushing seat is adjacent to the first end and is provided with an American receiving hole along the reference axis, wherein the American pushing seat is provided with a first containing slot, and the first clamping jaw is disposed in the first containing slot, wherein the French pushing seat is adjacent to the second end and is provided with a French receiving hole along the reference axis, wherein the French pushing seat is provided with at least one second containing slot, and the at least one second clamping jaw is disposed in the at least one second containing slot, wherein the pushing member is disposed in the American receiving hole, wherein the first clamping jaw includes a first pivoting base and a first clamping arm, wherein the first pivoting base is provided with a first pivoting portion, wherein the first clamping arm is pivotally connected to the first pivoting base and is provided with a first clamping portion, wherein the at least one second clamping jaw includes a second pivoting base and a second clamping arm, wherein the second pivoting base is provided with a second pivoting portion, wherein the second clamping arm is pivotally connected to the second pivoting base and is provided with a second clamping portion, wherein the clamping device is slidable between an American position and a French position;
wherein when the clamping device is in the American position, the first clamping portion and the first pivoting portion are close to the reference axis, and the second clamping portion and the second pivoting portion are away from the reference axis;
wherein when the clamping device is in the French position, the first clamping portion and the first pivoting portion are away from the reference axis, and the second clamping portion and the second pivoting portion are close to the reference axis.

2. The valve connector of claim 1, wherein an inner periphery of the sliding slot is provided with a first pushing surface adjacent to the first end and a second pushing surface adjacent to the second end, wherein the first pivoting base is provided with a third pivoting portion pivotally connected to the American pushing seat, and wherein the second pivoting base is provided with a fourth pivoting portion pivotally connected to the French pushing seat;
wherein when the clamping device is in the American position, the first pivoting portion contacts the first pushing surface, causing the first clamping portion to move closer to the reference axis, and the second pivoting portion disengages from the second pushing surface, causing the second clamping portion to move away from the reference axis;
wherein when the clamping device is in the French position, the first pivoting portion disengages from the first pushing surface, causing the first clamping portion to move away from the reference axis, and the second pivoting portion contacts the second pushing surface, causing the second clamping portion to move closer to the reference axis.

3. The valve connector of claim 2, wherein a distance from the first pivoting portion to the first end along the reference axis forms a first depth, wherein a distance from the first clamping portion to the first end along the reference axis forms a second depth, and wherein the first depth is less than the second depth, wherein a distance from the second pivoting portion to the second end along the reference axis forms a third depth, wherein a distance from the second clamping portion to the second end along the reference axis forms a fourth depth, and wherein the third depth is less than the fourth depth, wherein the clamping device slides between the American position and the French position to allow the first clamping jaw to rotate relative to the American pushing seat and the at least one second clamping jaw to rotate relative to the French pushing seat.

4. The valve connector of claim 3, wherein a distance from the third pivoting portion to the first end along the reference axis forms a fifth depth, wherein the fifth depth is greater than the second depth, wherein a distance from the fourth pivoting portion to the second end along the reference axis forms a sixth depth, and wherein the sixth depth is greater than the fourth depth.

5. The valve connector of claim 2, wherein the clamping device includes a first elastic member and at least one second elastic member, wherein the first elastic member is a torsion spring disposed on the first pivoting portion, wherein two opposite ends of the first elastic member respectively press against the first pivoting base and the first clamping arm, wherein the at least one second elastic member is a torsion spring disposed on the second pivoting portion, and wherein two opposite ends of the at least one second elastic member respectively press against the second pivoting base and the second clamping arm.

6. The valve connector of claim 2, wherein the American pushing seat is provided with a first pin inserted into the American pushing seat, wherein the first pin is positioned within the first containing slots, wherein the third pivoting portion is sleeved on the first pin and pivotally connected to the American pushing seat, with the first pin serving as the center of rotation, wherein the French pushing seat is provided with at least one second pin inserted into the French pushing seat, wherein the at least one second pin is positioned within the at least one second containing slot, and wherein the fourth pivoting portion is sleeved on the at least one second pin and pivotally connected to the French pushing seat, with the at least one second pin serving as the center of rotation.

7. The valve connector of claim 2, wherein the French pushing seat is threadedly connected to the American pushing seat, wherein when the clamping device is in the American position, the American pushing seat and the French pushing seat move synchronously toward the second end, and the French pushing seat protrudes from the second end of the housing, and wherein when the clamping device is in the French position, the American pushing seat and the French pushing seat move synchronously toward the first end, and the American pushing seat protrudes from the first end of the housing.

8. The valve connector of claim 2, wherein the pushing member is inserted into the American receiving hole from an end of the American pushing seat adjacent to the second end, wherein the clamping device includes a spring sleeved on the pushing member, wherein one end of the spring abuts against the pushing member, and the other end of the spring abuts against the French pushing seat, and wherein the spring is configured to push against the pushing member to move away from the French pushing seat.

9. The valve connector of claim 2, wherein an inner periphery of the American receiving hole is provided with an American sealing ring disposed on a side of the first clamping portion opposite to the first end, and wherein an periphery of the French receiving hole is provided with a French sealing ring disposed between the second clamping portion and the second end.

10. The valve connector of claim 2, wherein the inner periphery of the sliding slot is provided with a limiting flange, wherein the American pushing seat is disposed between the limiting flange and the first end, wherein the French pushing seat is disposed between the limiting flange and the second end, wherein when the clamping device is in the American position, the American pushing seat contacts one end of the limiting flange adjacent to the first end, and wherein when the clamping device is in the French position, the French pushing seat contacts one end of the limiting flange adjacent to the second end.
